(19) United States
(12) Patent Application Publication
(10) Pub. No.: US 2026/0286043 A1
(43) Pub. Date: Sep. 24, 2026

(54) MOLDED BODY, DOWNHOLE TOOL MEMBER, AND DOWNHOLE TOOL

(71) Applicant: Kureha Corporation, Tokyo (JP)

(72) Inventors: Motoharu SHODA, Tokyo (JP); Takuma KOBAYASHI, Tokyo (JP); Fuminori KOBAYASHI, Tokyo (JP)

(73) Assignee: Kureha Corporation, Tokyo (JP)

(21) Appl. No.: 18/868,590

(22) PCT Filed: Mar. 28, 2023
(86) PCT No.: PCT/JP2023/012621

§ 371 Date: Nov. 22, 2024

(30) Foreign Application Priority Data
May 27, 2022 (JP) 2022-087085

(51) Int. Cl. C08G 63/664; C08G 63/06; C08K 3/28; C08K 3/34; C08K 5/1575; E21B 41/00

(52) U.S. Cl. CPC C08G 63/664; C08G 63/06; C08K 3/28; C08K 3/34; C08K 5/1575; E21B 41/00; C08K 2003/282

(57) ABSTRACT

Provided is a molded body with an improved thickness reduction rate after thickness reduction of 5 mm or greater from its initial thickness, while maintaining the tensile strength. The molded body of the present invention includes a composition containing a glycolic acid polymer, a cyclic ester, and an inorganic filler. In the composition, a content of the cyclic ester is 10 mass % or more and 22 mass % or less, and a content of the inorganic filler is 0.1 mass % or more and 15 mass % or less. The inorganic filler is selected from the group consisting of aluminum nitride and silicon nitride.

### TECHNICAL FIELD

The present invention relates to: a molded body including a composition containing a glycolic acid polymer; a downhole tool member including the molded body; and a downhole tool containing the downhole tool member.

### BACKGROUND ART

A glycolic acid polymer has high strength and is a degradable resin material having hydrolyzability and degradability. Because of such characteristics, glycolic acid polymers are used as medical materials such as bone fixation materials and sutures. Also, in recent years, their applications as a member of a downhole tool used for recovery of hydrocarbon resources is expanding. Depending on the applications, higher degradation rates are demanded, and various research and developments have been conducted to improve the degradation rates of glycolic acid polymers.

For example, Patent Document 1 discloses that glycolide, lactide, phthalic anhydride, or the like may be contained as a degradation accelerator in a degradable polymer material for forming a degradable sealing member for a downhole tool.

Furthermore, Patent Document 2 discloses that a molded article having an effective thickness of 1 mm or greater is formed from an aliphatic polyester resin composition containing a specific amount of a carboxylic anhydride, whereby the molded product has excellent degradability even at lower than 66° C.

### CITATION LIST

### Patent Document

Patent Document 1: JP 2015-143333 A
Patent Document 2: JP 2015-172106 A

### SUMMARY OF INVENTION

### Technical Problem

Further improvement in degradation rate of a molded body is demanded in use of a molded body containing a glycolic acid polymer in a member of a downhole tool. In particular, it is required that a molded body having a thickness of greater than 5 mm has an improved thickness reduction rate after thickness reduction of 5 mm or greater from its initial thickness while maintaining the tensile strength.

An object of an embodiment of the present invention is to realize a molded body having an improved thickness reduction rate after thickness reduction of 5 mm or greater from its initial thickness while maintaining the tensile strength.

### Solution to Problem

As a result of intensive studies, the present inventors have found that a specific cyclic ester and a specific inorganic filler are contained in a composition containing a glycolic acid polymer, thereby improving the thickness reduction rate of a molded body after thickness reduction of 5 mm or greater from its initial thickness. Moreover, the present inventors have also found that the reduction in tensile strength of the molded body at 49° C. is suppressed, and thus the present invention has been completed.

A molded body according to an embodiment of the present invention is a molded body including a composition containing a glycolic acid polymer, a cyclic ester, and an inorganic filler, in which, in the composition, a content of the cyclic ester is 10 mass % or more and 22 mass % or less, a content of the inorganic filler is 0.1 mass % or more and 15 mass % or less, the inorganic filler is at least one inorganic filler selected from the group consisting of aluminum nitride and silicon nitride, and the molded body has a thickness or a diameter of greater than 5 mm.

### Advantageous Effects of Invention

According to an embodiment of the present invention, it is possible to provide a molded body having an improved thickness reduction rate after thickness reduction of 5 mm or greater from its initial thickness while maintaining the tensile strength.

### DESCRIPTION OF EMBODIMENTS

### Molded Body

A molded body according to an embodiment of the present invention includes a composition containing a glycolic acid polymer, a cyclic ester, and an inorganic filler.

### Glycolic Acid Polymer

In the present specification, the glycolic acid polymer is a polymer containing a repeating unit (-(—O—CH₂—CO—)-) derived from glycolic acid. The glycolic acid polymer may be a homopolymer of glycolic acid (polyglycolic acid (PGA)). Furthermore, the glycolic acid polymer may be a copolymer containing a repeating unit derived from glycolic acid and a repeating unit derived from another monomer.

The copolymer containing a repeating unit derived from glycolic acid and a repeating unit containing another monomer (hereinafter, referred to as “glycolic acid copolymer”) will be described below.

### Glycolic Acid Copolymer

From the perspective of improvement in degradation rate, the glycolic acid copolymer may be a copolymer including two or more linear polymer chains A, each containing a repeating unit derived from glycolic acid, chemically bonded to a polymer chain B that is different from the polymer chain A. The polymer chain A and the polymer chain B will be described below.

In the glycolic acid copolymer, two or more polymer chains A may be chemically bonded to the polymer chain B, and bonding positions of the polymer chains A in the polymer chain B are not particularly limited. For example, the copolymer may be a triblock copolymer, in which a polymer chain A is chemically bonded to both terminals of the main chain of a polymer chain B (“ABA-type block copolymer”, where A is the polymer chain A, and B is the polymer chain B), or may be a graft copolymer, in which two or more polymer chains A are graft-bonded to a polymer chain B.

From the perspective of excellent improvement effect in thickness reduction rate during degradation in the production of a molded body using the glycolic acid copolymer, the copolymer is preferably an ABA-type block copolymer (where A is the polymer chain A, and B is the polymer chain B).

Furthermore, in the glycolic acid copolymer, the polymer chain A and the polymer chain B are preferably bonded via an ester bond. Consequently, an improvement effect in thickness reduction rate during degradation in the production of a molded body using the glycolic acid copolymer composition is readily achieved.

In particular, in a case where the polymer chain B is a unit having a higher hydrophilicity or flexibility than that of the polymer chain A, the polymer chain A and the polymer chain B are particularly preferably bonded via an ester bond. Specifically, in a case where the polymer chain B is a unit having a higher hydrophilicity or flexibility than that of the polymer chain A, water tends to permeate around the polymer chain B rather than around the polymer chain A, and the ester bond between the polymer chain A and the polymer chain B readily hydrolyzes compared to the ester bond in the polymer chain A. Namely, the glycolic acid copolymer is ruptured between the polymer chain A and the polymer chain B upon hydrolysis of the ester bond between the polymer chain A and the polymer chain B, leading to dramatic reduction of its molecular weight, and thus the thickness reduction rate tends to be improved.

The polymer chain A and the polymer chain B constituting the glycolic acid copolymer will be described below.

### Polymer Chain A

Examples of the polymer chain A include a linear polymer chain containing a glycolic acid unit. The number of glycolic acid units constituting one block of the polymer chain A in the glycolic acid copolymer are not particularly limited, and can be appropriately determined in such a range that the glycolic acid copolymer can exhibit degradability originating from the polymer chain A.

### Polymer Chain B

The polymer chain B is a polymer chain different from the polymer chain A. For example, the polymer chain B may be a polymer chain derived from a polymer compound having a glass transition temperature (Tg) of lower than 45° C. Furthermore, the polymer chain B may be a polymer chain derived from a polymer compound having a weight average molecular weight of 1500 or greater and 250000 or less.

The glass transition temperature of the polymer compound as the source of the polymer chain B (hereinafter, “polymer compound B”) is preferably 45° C. or lower, and more preferably 0° C. or lower, from the perspective of making the glass transition temperature of the glycolic acid copolymer lower than that of a polymer consisting of the polymer chain A only. The glass transition temperature of the polymer compound as the source of the polymer chain B can be measured by differential scanning calorimetry (DSC).

The weight average molecular weight of the polymer compound B is preferably 2500 or greater, more preferably 3000 or greater, and even more preferably 7500 or greater, from the perspective of further improving the thickness reduction rate of the molded body during degradation. From the perspective of improving strength of the molded body, the weight average molecular weight of the polymer compound B is preferably 50000 or less, and more preferably 20000 or less. The polymer compound B having a weight average molecular weight of 50000 or less is advantageous from the perspectives of solubility in glycolide during polymerization of the glycolic acid copolymer and control of copolymerizability. The weight average molecular weight of the polymer compound B can be measured by a gel permeation chromatography (GPC) instrument.

The polymer compound B is not particularly limited as long as the polymer compound B is a polymer compound that is not polyglycolic acid and that has, at two or more terminals, functional groups capable of chemically bonding with glycolic acid units constituting the polymer chain A to function as a polymerization initiator and has a weight average molecular weight and/or a glass transition temperature in the specific ranges described above.

Examples of the polymer compound B described above include a polyol having the specific weight average molecular weight and glass transition temperature described above. Examples of the polyol include polyethylene glycol, polypropylene glycol, polytetramethylene ether glycol, polycaprolactone, polydioxanone, polydimethylsiloxane, and polyethylene oxalate. “Polyol” may be a homopolymer containing only one type of repeating unit, or may be a copolymer further containing a repeating unit derived from another monomer.

From the perspective of imparting hydrophilicity to the glycolic acid copolymer, the polymer compound B is preferably a hydrophilic polyhydric alcohol-based polymer having a terminal hydroxy group. Examples of the hydrophilic polyhydric alcohol-based polymer having a terminal hydroxy group include polyethylene glycol, polypropylene glycol, polyglycerin, and polyvinyl alcohol.

In an embodiment of the present invention, the polymer compound B may be a hydrophilic polyhydric alcohol having a terminal hydroxy group and having a weight average molecular weight of 3000 or greater and 50000 or less. When the polymer compound B is a hydrophilic polyhydric alcohol having a terminal hydroxy group and having a weight average molecular weight of 3000 or greater and 50000 or less, the hydrophilicity of the polymer chain B is exhibited in the glycolic acid copolymer, and thus affinity for water during degradation improves. As a result, an effect of further improving the thickness reduction rate of the molded body during degradation is achieved.

In another embodiment of the present invention, the polymer compound B may be polyethylene glycol or polypropylene glycol having a weight average molecular weight of 3000 or greater and 50000 or less. The polyethylene glycol and polypropylene glycol have a particularly low glass transition temperature and particularly high hydrophilicity. Thus, when the hydrophilic polyhydric alcohol having a terminal hydroxy group is polyethylene glycol or polypropylene glycol, an effect of imparting flexibility and hydrophilicity to the glycolic acid copolymer is achieved.

In another embodiment of the present invention, the polymer compound B may be polyethylene glycol having a weight average molecular weight of 7500 or greater and 50000 or less. When the polymer compound B is polyethylene glycol having a weight average molecular weight of 7500 or greater and 50000 or less, an effect of further improving the thickness reduction rate of the molded body during degradation is achieved.

The polymer compound B may be a homopolymer containing a repeating unit derived from one monomer, or may be a copolymer further containing a repeating unit derived from another monomer.

Examples of such other monomers include cyclic monomers such as ethylene oxalate (1,4-dioxane-2,3-dione), lactides, lactones (e.g., β-propiolactone, β-butyrolactone, β-pivalolactone, γ-butyrolactone, δ-valerolactone, β-methyl-δ-valerolactone, and ε-caprolactone), carbonates (e.g., trimethylene carbonate), ethers (e.g., 1,3-dioxane), ether esters (e.g., dioxanone), and amides (e.g., Ecaprolactam); hydroxycarboxylic acids and alkylesters thereof, such as lactic acid, 3-hydroxypropanoic acid, 3-hydroxybutanoic acid, 4-hydroxybutanoic acid, and 6-hydroxycaproic acid; mixtures containing substantially equimolar amounts of an aliphatic diol, such as ethylene glycol, propylene glycol, tetramethylene ether glycol, or 1,4-butanediol, and an aliphatic dicarboxylic acid, such as succinic acid or adipic acid, or an alkylester thereof; and two or more types of these.

The repeating unit derived from another monomer can be used from the perspective of adjusting physical properties of the polymer compound B. For example, use of the other repeating unit allows adjustment of the affinity of the polymer compound B for water. The content of another repeating unit in the polymer compound B can be appropriately determined in such a range that the desired effect of the polymer chain B is adequately achieved. The content of a repeating unit derived from another monomer in the polymer compound B may be 50 mass % or less, and is preferably 30 mass % or less, and even more preferably 10 mass % or less. The polymer compound B may be linear, or may be a graft copolymer to which another polymer compound is graft-bonded.

The polymer chain B may have an ester bond in a molecule. When the polymer chain B has an ester bond in a molecule, rupture resulting from hydrolysis of an ester bond also occurs in the polymer chain B, the thickness reduction rate tends to be further improved.

From the perspectives of allowing the hydrophilicity of the polymer chain B to be adequately exhibited in the glycolic acid copolymer and improving the thickness reduction rate of the molded body during degradation, the amount of the polymer chain B in the glycolic acid copolymer is, in mass ratio, preferably 0.5 or greater, and more preferably 1.5 or greater, relative to a total amount of the polymer chain A of 100. Furthermore, from the perspective of maintaining the strength of the glycolic acid copolymer, the amount of the polymer chain B in the glycolic acid copolymer is, in mass ratio, preferably 30 or less, and more preferably 20 or less, relative to the total amount of the polymer chain A of 100.

The glycolic acid polymer can be produced by a known method. For example, the glycolic acid copolymer can be suitably produced by ring-opening polymerization of glycolide, which is a glycolic acid dimer, in the presence of a small amount of a catalyst and in the substantial absence of a solvent (i.e., under bulk polymerization conditions) using the polymer compound B, which is the source of the polymer chain B, as a polymerization initiator. The reaction temperature in the ring-opening polymerization can be appropriately determined in such a range that the ring-opening polymerization of glycolide can appropriately proceed, and is, for example, 140° C. Examples of the catalyst include a cationic catalyst such as an organotin carboxylate, a tin halide, and an antimony halide. Commercially available products of the glycolic acid polymer may also be used.

### Cyclic Ester

The cyclic ester contained in the composition may be, for example, at least one cyclic ester selected from the group consisting of glycolide, lactide, epsilon-caprolactone, gamma-valerolactone, delta-valerolactone, diglycolic anhydride, and glutaric anhydride, and a cyclic ester selected from the group consisting of glycolide, lactide, epsilon-caprolactone, gamma-valerolactone, and delta-valerolactone is preferable. Among the cyclic esters, glycolide is more preferable because of its chemical structure having the highest miscibility with PGA. One type of cyclic ester may be used alone, or two or more types thereof may be used in combination.

### Fedors Solubility Parameter

In the composition according to the present embodiment, the absolute value of the difference between the Fedors solubility parameter of the cyclic ester and the Fedors solubility parameter of the glycolic acid polymer is 6 (J/cm³)^{1/2} or less, preferably 5.5 (J/cm³)^{1/2} or less, and more preferably 5 (J/cm³)^{1/2} or less. Hereinafter, “Fedors solubility parameter” may be abbreviated as “SP value”. When the absolute value of the difference between the SP value of the cyclic ester and the SP value of the glycolic acid polymer is within the range described above, the composition has sufficient plasticity.

The SP value can be calculated, for example, according to “SP value δ Foundation/Application and Calculation Method” (published by Johokiko Co., Ltd. (2005) pp. 66-67) by Hideki Yamamoto. More specifically, the SP value δ ((cal/cm³)^{1/2}) of a target compound (glycolic acid polymer or cyclic ester) is calculated according to the following equation (1).

$$δ = {( \sum Ecoh / \sum V )}^{1 / 2} \qquad ( 1 )$$

In Equation (1), ΣEcoh represents the sum total of Ecoh (cohesive energy density of a structural unit of a target compound (cal/cm³)), and ΣV represents V (molar volume of a structural unit of a target compound (cm³)).

When two or more types of cyclic esters are contained in the composition, the absolute value of the difference between the SP value of at least one type of cyclic ester and the SP value of glycolic acid polymer is 6 (J/cm³)^{1/2} or less.

The content of the cyclic ester in the composition is 10 mass % or more, preferably 12 mass % or more, and more preferably 15 mass % or more relative to 100 mass % of the composition. In addition, the content is 22 mass % or less, preferably 20 mass % or less, more preferably 18 mass % or less, and still more preferably 17 mass % or less. When the content of the cyclic ester is within the range described above, the glass transition temperature (Tg) of the composition can be sufficiently lowered, and sufficient plasticity can be imparted to the composition.

### Inorganic Filler

The inorganic filler contained in the composition is at least one inorganic filler selected from the group consisting of aluminum nitride and silicon nitride. The inorganic filler is a nitride that is hydrolyzed upon contact with water to produce ammonia. By the produced ammonia, a nearby glycolic acid polymer is hydrolyzed to form microvoids. It is presumed that the presence of microvoids in the glycolic acid polymer composition improves the diffusion of water and therefore leads to acceleration of degradation. Among the inorganic fillers, aluminum nitride that is susceptible to hydrolysis is preferable. One type of inorganic filler may be used alone, or two or more types thereof may be used in combination.

The shape of the inorganic filler is not particularly limited, and examples that can be used include fibrous, whisker-shaped, plate-shaped (layered), and powdery or particulate inorganic fillers. The inorganic filler preferably has a particulate form. When the inorganic filler has a particulate form, the aggregation of the inorganic filler can be suppressed. In addition, the specific surface area of the inorganic filler when in contact with the polymer matrix increases, and the contact efficiency at the interface between the inorganic filler and the polymer matrix can be increased, and therefore the degradation rate is improved.

The content of the inorganic filler in the composition is 0.1 mass % or more, preferably 0.3 mass % or more, more preferably 0.5 mass % or more, and still more preferably 1 mass % or more relative to 100 mass % of the composition. Furthermore, the content is 15 mass % or less, preferably 10 mass % or less, more preferably 5 mass % or less, and still more preferably 3 mass % or less relative to 100 mass % of the composition. When the content of the inorganic filler is within the range described above, the amount of water absorption of the molded body including the composition is improved due to degradation of the inorganic filler, and the thickness reduction rate of the molded body is further improved.

From the perspectives of improving the thickness reduction rate in the late stage of degradation and improving the tensile strength of the molded body, the contents of the cyclic ester and the inorganic filler in the composition each are more preferably 10 mass % or more and 15 mass % or less, and still more preferably 12 mass % or more and 5 mass % or less relative to 100 mass % of the composition.

### Weight Average Molecular Weight of Composition

The weight average molecular weight (Mw) of the composition is preferably 150000 or greater, more preferably 160000 or greater, and even more preferably 170000 or greater, from the perspectives of maintaining of the strength of the molded body and extrusion molding. Furthermore, from the perspective of facilitating molding at the time of extrusion molding or injection molding, the Mw of the composition is preferably 500000 or less, more preferably 450000 or less, and even more preferably 400000 or less.

The weight average molecular weight of the composition can be measured by, for example, the method described below. Approximately 10 mg of the composition is dissolved in 0.5 mL of DMSO by heating at 150° C., and then cooled to room temperature. The cooled solution is diluted to 10 mL with hexafluoroisopropanol (HFIP), and the weight average molecularweight of the composition is measured by using a gel permeation chromatograph (GPC) instrument. As the standard substance, polymethyl methacrylate (PMMA) is used. An example of the GPC instrument is Shodex GPC-104 (detector: RI, column: two HFIP-606M). Furthermore, as a solvent, HFIP containing 5 mM CF₃COONa may be used.

### Additional Components

Besides the glycolic acid polymer, the cyclic ester, and the inorganic filler, the composition may contain an additional component in a range not contrary to the object of the present invention.

Examples of the additional component include various additives such as a plasticizer, a thermal stabilizer, a photostabilizer, a desiccant, a waterproofing agent, a water repellent, a lubricant, a hydrophilic agent, a water absorbent, a nucleating agent, and a pore forming agent. In addition, the composition may contain a polymerization initiator, a catalyst, or the like used in preparation of a polymer.

In the present specification, a degradation accelerator means a reagent (compound) that accelerates a hydrolysis reaction of the composition containing the glycolic acid polymer. Examples of the degradation accelerator include a carboxylic anhydride and a phosphorus compound. One type of degradation accelerators may be used alone, or two or more types of degradation accelerators may be used in combination.

The carboxylic anhydride in the composition is not particularly limited. From the perspective of heat resistance to withstand the temperature when molding the composition and from the perspective of miscibility with the composition, a carboxylic anhydride having a ring structure is preferable, and hexanoic anhydride, octanoic anhydride, decanoic anhydride, lauric anhydride, mystyric anhydride, palmitic anhydride, stearic anhydride, benzoic anhydride, succinic anhydride, maleic anhydride, phthalic anhydride, trimellitic anhydride, tetrahydrophthalic anhydride, butanetetracarboxylic dianhydride, 3,3′,4,4′-benzophenonetracarboxylic dianhydride, diphenylsulfone tetracarboxylic dianhydride, biphenyltetracarboxylic dianhydride, ethylene glycol bisanhydrotrimellitate, glycerin bisanhydrotrimellitate monoacetate, and benzene-1,2,4,5-tetracarboxylic anhydride (pyromellitic anhydride) are more preferable, phthalic anhydride, trimellitic anhydride, benzoic anhydride, 3,3′,4,4′-benzophenonetetracarboxylic dianhydride, benzene-1,2,4,5-tetracarboxylic anhydride (pyromellitic anhydride) are particularly preferable.

The phosphorus compound in the composition is not particularly limited, and the phosphorus compound is preferably an organophosphorus compound such as phosphate and phosphite esters. Of these, the organophosphorus compound having at least one structure selected from the group consisting of a long-chain alkyl group having from 8 to 24 carbons, an aromatic ring, and a pentaerythritol skeleton is more preferable.

Examples of the phosphate ester having a long-chain alkyl group having from 8 to 24 carbons include mono- or di-stearyl acid phosphate or their mixture, and di-2-ethylhexyl acid phosphate. Examples of the phosphite ester having an aromatic ring include tris(nonylphenyl) phosphite. Examples of the phosphite ester having a pentaerythritol skeleton structure include cyclic neopentanetetraylbis(2,6-di-tert-butyl-4-methylphenyl)phosphite, cyclic neopentanetetraylbis(2,4-di-tert-butylphenyl)phosphite, and cyclic neopentanetetraylbis(octadecyl)phosphite.

The content of the degradation accelerator in the composition is preferably 1 mass %, and more preferably 3 mass % or greater, relative to 100 mass % of the composition. In addition, the content is preferably 10 mass % or less, more preferably 7 mass % or less, and still more preferably 5 mass % or less relative to 100 mass % of the composition. When the content of the degradation accelerator is in the range, the degradation accelerator is less likely to bleed out from the composition, and thus molding processing of the composition can be facilitated while the degradation rate of the composition is accelerated.

The composition can be prepared by mixing a glycolic acid polymer, a cyclic ester, and an inorganic filler. The cyclic ester may be added during the preparation of the glycolic acid polymer. When the glycolic acid polymer is produced by ring-opening polymerization of glycolide, the remaining glycolide may be used as a cyclic ester. That is, a glycolic acid polymer composition containing glycolide and the glycolic acid polymer and obtained by the preparation of the glycolic acid polymer, an inorganic filler, and an optional plasticizer may be mixed to prepare the composition.

A molded body according to an embodiment of the present invention is a polyglycolic acid molded body including the composition. The thickness or diameter of the molded body is greater than 5 mm.

When the molded body according to an embodiment of the present invention is held in water at 49° C., the thickness reduction rate of the molded body after thickness reduction of 5 mm or greater from its initial thickness (the thickness of the molded body before being held in water) is preferably 0.070 mm/hour or greater, and more preferably 0.090 mm/hour or greater. Hereinafter, the “molded body after thickness reduction of 5 mm or greater from its initial thickness when held in water at 49° C.” may be referred to as a “molded body in the late stage of degradation”. When the thickness reduction rate of the molded body in the late stage of degradation is 0.070 mm/hour or greater, the time required for complete degradation of the molded body within a desired time can be shortened. For this reason, the thickness of the molded body can be increased, and an effect of ensuring a high strength of the molded body is attained. In other words, an effect of improving the strength of the molded body is attained as the thickness of the molded body can be increased.

When the thickness reduction rate of the molded body after thickness reduction of 5 mm or greater from its initial thickness when held in water at 49° C. is 0.070 mm/hour or greater, the molded body according to an embodiment of the present invention preferably has a tensile strength at 49° C. of 52 MPa or higher, more preferably of 54 MPa or higher, and still more preferably of 56 MPa or higher. When the tensile strength is 52 MPa or higher, it is possible to reduce the molded body thickness required to function as a downhole tool, and an effect of shortening the time for complete degradation within a desired time is attained. In other words, since a part that functions as a downhole tool can be reduced in thickness, an effect of shortening the degradation time of the part is attained.

As described above, the molded body according to an embodiment of the present invention contains a specific cyclic ester and an inorganic filler. The cyclic ester plays a role in increasing the amount of water absorption of the glycolic acid polymer and accelerating the degradation of the molded body. In addition, the amount of water absorption of the glycolic acid polymer is increased by the degradation of the inorganic filler, and the degradation of the molded body is accelerated. It is presumed that, in the molded body containing the specific cyclic ester and inorganic filler, a base component produced by degradation of the inorganic filler promotes the dissolution of the cyclic ester and the diffusion rate of water in the molded body is improved, thereby improving the thickness reduction rate of the molded body in the late stage of degradation. As shown in Examples, as compared with a molded body containing only a cyclic ester and a molded body containing only an inorganic filler, the molded body according to an embodiment of the present invention has a high thickness reduction rate in the late stage of degradation while maintaining the tensile strength, owing to the synergistic effect of the specific cyclic ester and inorganic filler.

### Method of Producing a Molded Body

The molded body according to the present embodiment can be produced by molding the composition described above. The molding method is not limited. Examples of the method include injection molding, melt extrusion molding, solidification- and extrusion-molding, compression molding (press molding), and centrifugal molding.

An example of production of the molded body by solidification- and extrusion-molding will be described. Pellets made of the composition are supplied to an extruder with a cylinder set at not lower than the melting point of the composition and 255° C. or lower (typically, from 200 to 255° C.), and melt-kneaded. Next, the melt-kneaded product is extruded through an extrusion die at the tip of the extruder into the flow path of a forming die, and cooled and solidified to a temperature that is not higher than the crystallization temperature of the composition in the flow path of the forming die, and the solidified product is extruded from the tip of the forming die to the outside at a speed of 5 to 50 mm/10 minutes. The extrudate is pressurized and pulled while applying a back pressure of 1500 to 8500 kg in the forming die direction to produce a molded body which is the solidification- and extrusion-molded product. The molded product may be annealed by a heat treatment at a temperature of 150 to 230° C. for 3 to 24 hours.

An example of production of the molded body by injection molding will be described. Pellets made of the composition are supplied to an injection molding machine equipped with a mold for injection molding. The temperature of the cylinder is set to not lower than the melting point of the composition and 255° C. or lower (typically, from 200 to 255° C.), and the mold temperature is set to 0° C. or higher and not higher than the melting point of the composition (typically, from 0 to 190° C.). Then, the pellets are injection-molded at an injection pressure of 1 to 104 MPa (preferably 10 to 104 MPa) to produce a molded body which is an injection-molded product. This molded product may be annealed at a temperature that is not lower than the crystallization temperature of the composition and not higher than the melting point (typically, from 70 to 220° C.) for 1 minute to 10 hours.

The thickness or diameter of the molded body is preferably 1 mm or greater, and more preferably 3 mm or greater, for example, from the perspective of machine processing into a downhole tool member. Furthermore, the upper limit of the thickness or diameter of the molded body is not particularly limited and is preferably 500 mm or less, and more preferably 400 mm or less.

### Downhole Tool Member

A downhole tool member according to an embodiment of the present invention is a member used for subterranean excavation to recover hydrocarbon resources such as petroleum and gas from underground, and includes the molded body. The molded body may be used as is as a downhole tool member, or may be subjected to a known machine processing (secondary processing) to produce a downhole tool member. Examples of the machine processing include cutting.

The shape and size of the downhole tool member according to an embodiment of the present invention are not particularly limited, and for example, the thickness or diameter is from 5 to 500 mm, preferably from 20 to 300 mm, and more preferably from 30 to 200 mm. The shape of the downhole tool member may be various shapes such as a round bar shape, a plate shape, a hollow product such as a pipe, and an irregularly shaped product. In terms of extrusion-molding and subsequent densification processing being easy and in terms of being often suitable for an extrusion-molded product which is a material for machining, the shape of the downhole tool member is preferably a round bar shape, a hollow product, or a plate shape. For the formation of a downhole tool member for petroleum excavation, in particular for the formation ofa blocking plug core rod, the shape of the downhole tool member is more preferably a round bar.

### Downhole Tool

A downhole tool according to an embodiment of the present invention includes a downhole tool member. In the present specification, a device or a component thereof that is used for various well treatments such as well drilling, well closure, and fracturing and that is placed in the well is referred to as a downhole tool. The shape of the downhole tool is not particularly limited and, for example, can be a known shape. Examples of the downhole tool include a flack plug, a bridge plug, a cement retainer, a perforation gun, a ball sealer, a blocking plug, and a packer.

### SUMMARY

A molded body according to a first embodiment of the present invention includes a composition containing a glycolic acid polymer, a cyclic ester, and an inorganic filler, in which, in the composition, a content of the cyclic ester is 10 mass % or more and 22 mass % or less, a content of the inorganic filler is 0.1 mass % or more and 15 mass % or less, the inorganic filler is at least one inorganic filler selected from the group consisting of aluminum nitride and silicon nitride, and the molded body has a thickness or a diameter of greater than 5 mm.

A molded body according to a second embodiment of the present invention is the molded body in the first embodiment, in which a thickness reduction rate of the molded body after thickness reduction of 5 mm or greater from its initial thickness when held in water at 49° C. may be 0.070 mm/hour or greater.

A molded body according to a third embodiment of the present invention is the molded body in the first or second embodiment, in which the molded body may have a tensile strength at 49° C. of 52 MPa or greater, and a thickness reduction rate of the molded body after thickness reduction of 5 mm or greater from its initial thickness when held in water at 49° C. may be 0.070 mm/hour or greater.

A molded body according to a fourth embodiment of the present invention is the molded body in any one of the first to third embodiments, in which the cyclic ester in the composition may be glycolide.

A molded body according to a fifth embodiment of the present invention is the molded body in any one of the first to fourth embodiments, in which the content of the cyclic ester in the composition may be 20 mass % or less.

A molded body according to a sixth embodiment of the present invention is the molded body in any one of the first to fifth embodiments, in which the content of the inorganic filler in the composition may be 10 mass % or less.

A molded body according to a seventh embodiment of the present invention is the molded body in any one of the first to sixth embodiments, in which the glycolic acid polymer may be a copolymer in which a linear polymer chain A including a repeating unit derived from glycolic acid is chemically bonded to a polymer chain B different from the polymer chain A.

A molded body according to an eighth embodiment of the present invention is the molded body in the seventh embodiment, in which the polymer chain B may be derived from a polymer compound having a glass transition temperature of lower than 45° C.

A molded body according to a ninth embodiment of the present invention is the molded body in the seventh or eighth embodiment, in which the glycolic acid polymer may be a block copolymer of the polymer chain A and the polymer chain B.

A molded body according to a tenth embodiment of the present invention is the molded body in the seventh embodiment, in which the glycolic acid polymer may be a homopolymer of glycolic acid.

A molded body according to an eleventh embodiment of the present invention is the molded body in any one of the first to tenth embodiments, in which the composition may have a weight average molecular weight of 150000 or greater and 500000 or less.

A downhole tool member according to a twelfth embodiment of the present invention includes the molded body described in any one of the first to eleventh embodiments.

A downhole tool according to a thirteenth embodiment of the present invention includes the downhole tool member described in the twelfth embodiment.

Embodiments of the present invention will be further described in detail using the examples below. The present invention is not limited to the examples below, and it goes without saying that various embodiments with regard to the details thereof are possible. Furthermore, the present invention is not limited to the above-described embodiments, and various modifications can be made within the scope indicated in the claims, and embodiments obtained by appropriately combining technical means disclosed in different embodiments are also included in the technical scope of the present invention. In addition, the contents of all the literature referred to herein are incorporated herein by reference in their entirety.

### EXAMPLES

Hereinafter, a glycolic acid polymer composition obtained by polymerization is referred to as a “polymer composition”. In addition, a composition containing a glycolic acid polymer (or a polymer composition), a cyclic ester, and an inorganic filler is simply referred to as a “composition”. In addition, the composition of the glycolic acid polymer used for the measurement of the following SP values is simply referred to as a “mixture”.

In the following Examples, the symbol “%” represents mass % unless otherwise noted.

### Measurement of SP Values of Glycolic Acid Polymer and Cyclic Ester

The measurement of the SP values was performed in accordance with “SP value: Foundation/Application and Calculation Method” (published by Johokiko Co., Ltd. (2005) pp. 66-67) by Hideki Yamamoto. More specifically, the SP value δ ((cal/cm³)^{1/2}) of a target compound (the glycolic acid polymer or the cyclic ester) was calculated according to the following equation (1).

$$δ = {( \sum Ecoh / \sum V )}^{1 / 2} \qquad ( 1 )$$

In Equation (1), ΣEcoh represents the sum total of Ecoh (cohesive energy density of a structural unit of a target compound (cal/cm³)), and FV represents V (molar volume of a structural unit of a target compound (cm³)).

The measurement results of the SP values, the difference between the SP value of the cyclic ester and the SP value of the glycolic acid polymer, and the glass transition temperature of the mixture are shown in Table 1. Note that the SP value of the glycolic acid polymer is 26.8. In addition, when two cyclic esters are contained in the mixture, the difference between the SP value of the cyclic ester and the SP value of the glycolic acid polymer is the one having a larger absolute value, of the value of the difference between the SP value of one cyclic ester and the SP value of the glycolic acid polymer and the value of the difference between the SP value of the other cyclic ester and the SP value of the glycolic acid polymer.

TABLE 1

| | | | | | | Difference | Glass |
|---|---|---|---|---|---|---|---|
| | | | | | SP value | in SP value | transition |
| | | | | | (J/cm³)^{1/2} | between | temperature |
| Glycolic acid | Cyclic ester 1 | | Cyclic ester 2 | | of cyclic | cyclic ester | Tg (° C.) of |
| polymer | Name | wt. % | Name | wt. % | ester | and PGA | mixture |
| Polyglycolic acid | — | — | — | — | — | — | 45 |
| Polyglycolic acid | Glycolide | 7.5 | — | — | 26.8 | 0 | 38 |
| Polyglycolic acid | Lactide | 9.3 | — | — | 23.1 | −3.7 | 37 |
| Polyglycolic acid | γ-Valerolactone | 6.5 | — | — | 21.6 | −5.2 | 29 |
| Polyglycolic acid | δ-Valerolactone | 6.5 | — | — | 21 | −5.8 | 31 |
| Polyglycolic acid | Diglycolic anhydride | 7.5 | — | — | 27.9 | 1.1 | 32 |
| Polyglycolic acid | Glutaric anhydride | 7.4 | — | — | 25.9 | −0.9 | 35 |
| Polyglycolic acid | Glycolide | 8 | Lactide | 9.3 | 23.1 | −3.7 | 25 |
| Polyglycolic acid | Glycolide | 8 | γ-Valerolactone | 6.5 | 21.6 | −5.2 | 17 |
| Polyglycolic acid | Glycolide | 8 | δ-Valerolactone | 6.5 | 21 | −5.8 | 19 |
| Polyglycolic acid | Glycolide | 8 | Diglycolic anhydride | 7.5 | 27.9 | 1.1 | 20 |
| Polyglycolic acid | Glycolide | 8 | Glutaric anhydride | 7.4 | 25.9 | −0.9 | 23 |

### Evaluation of Composition and Molded Body

The following evaluations were performed for the compositions and the molded bodies obtained in Examples and Comparative Examples.

### Measurement of Weight Average Molecular Weight of Molded Body

Approximately 10 mg of a sample was heated and dissolved in 0.5 mL of DMSO at 150° C. and then cooled to room temperature. The cooled solution was diluted to 10 mL with hexafluoroisopropanol (HFIP), and the weight average molecular weight of the composition was measured by using a GPC instrument. As the standard substance, polymethyl methacrylate (PMMA) was used. The measurement conditions are indicated below.

Instrument: Shodex GPC-104 (detector: RI, columns: two HFIP-606M)

Solvent: 5 mM CF₃COONa in HFIP

### Measurement of Glycolide Content in Molded Body

In approximately 100 mg of a sample, p-chlorobenzophenone-containing DMSO (0.4 mg/2 mL) was added and heated and dissolved at 150° C. for approximately 10 minutes. After the solution was cooled to room temperature, the solution was filtered. Gas chromatography (GC) measurement was performed for the obtained filtrate. The measurement conditions are indicated below.

Instrument: GC-2010, available from the Shimadzu Corporation

Column: RESTEK Rxi-5 ms

Column temperature: Retention at 150° C. for 5 minutes, (then temperature increase at 20° C./min), and then retention at 270° C. for 3 minutes Injection temperature: 180° C.

### Measurement of Thickness Reduction Rate of Molded Body

For the molded body, a required number of cubic test pieces with sides of 13 mm or 40 mm were prepared. Next, the test piece was placed in a 1 L autoclave at a temperature of 49° C. An immersion test was then performed by filling the autoclave with water (deionized water). The test piece was retrieved after immersion at predetermined time intervals, and the cross-sectional surface was cut and exposed. After the test piece was left to stand overnight in a dry room and dried, the thickness of the core part (hard portion) of the test piece was measured. A reduced thickness was determined based on the difference from the thickness before immersion (initial thickness was specifically 13 mm or 40 mm). The change of the reduced thickness of the test piece over time was determined based on the measured value of the reduced thickness of the test piece measured for different immersion time periods. Here, a period of time during which the reduced thickness is within a range from 0 to 5 mm is defined as an early stage of degradation, and a period of time during which the reduced thickness is 5 mm or greater is defined as a late stage of degradation. The thickness reduction rate of the test piece having a thickness of 13 mm or 40 mm was calculated from the change of the reduced thickness of the test piece over time within the range of the early stage of degradation or the late stage of degradation (unit: mm/h).

### Measurement of Tensile Strength of Molded Body

A molded article having an effective thickness of 5 mm or greater according to the present invention can be found to have practically sufficient tensile strength when the tensile strength measured by using a predetermined test piece is 52 MPa or greater. The tensile strength of the test piece can be measured according to ISO 527-1. A test piece (No. 5 test piece) having a shape defined in ISO 527-1 was subjected to a tensile test at a speed of 20 mm/min at 49° C. (49° C.±1° C. in temperature), and the maximum point stress exhibited until the test piece was broken was calculated and defined as the tensile strength of the test piece (an average value of five pieces (n=5), unit: MPa).

### Example 1

In a polymerization vessel, relative to 100 parts by mass of glycolide, 0.03 parts by mass of tin dichloride as a catalyst, 1 part by mass of pentaerythritol tetrakis[3-(3,5-di-tert-butyl-4-hydroxyphenyl)propionate] as a thermal stabilizer, 2 parts by mass of polyethylene glycol (PEG, Mw 7500) as a polymerization initiator were charged. The charged contents were held under heating conditions at 140° C. for 6 hours to obtain a polymer composition 1. Glycolide was not contained in the polymer composition 1.

Glycolide (GL) as a cyclic ester, aluminum nitride (AlN) as an inorganic filler, pyromellitic dianhydride (PMDA) as a degradation accelerator, and a mixture of distearyl acid phosphate and monostearyl acid phosphate (“ADK STAB AX-71” available from ADEKA CORPORATION) as a thermal stabilizerwere blended to the polymer composition 1 to obtain a composition. The contents of the cyclic ester, the inorganic filler, and the degradation accelerator contained in the composition are shown in Table 2.

The composition was supplied to a feed unit of a twin-screw extrusion kneader (“2D25S”, available from Toyo Seiki Seisaku-sho, Ltd.) with a screw temperature set at 190 to 240° C., melt-kneaded, and extrusion-molded, and thus pellets of the composition were obtained. Then, the pellets of the composition were supplied to a feed unit of an injection molding machine (“EC-100N”, available from Toshiba Machine Co., Ltd.) with a cylinder temperature set at 190 to 240° C. and injection-molded, and thus a molded body was obtained. The mold temperature in the injection molding was set to be within a range from 80 to 100° C.

### Examples 2 and 3

Compositions and molded bodies were obtained in the same procedure as in Example 1 except that the blending amounts of the cyclic ester and the inorganic filler were changed. The contents of the cyclic ester and the inorganic filler in Examples 2 and 3 are shown in Table 2.

### Example 4

A composition and a molded body were obtained in the same procedure as in Example 1 except that the blending amounts of the cyclic ester and the inorganic filler were changed and no degradation accelerator was blended. The contents of the cyclic ester, the inorganic filler, and the degradation accelerator in Example 4 are shown in Table 2.

### Example 5

In a polymerization vessel, relative to 100 parts by mass of glycolide, 0.003 parts by mass of tin dichloride as a catalyst and 0.3 parts by mass of 1-dodecanol as a polymerization initiator were charged. The charged contents were held under heating conditions at 170° C. for 2 hours to obtain a polymer composition 2. Glycolide was not contained in the polymer composition 2.

Glycolide (GL) as a cyclic ester, aluminum nitride (AlN) as an inorganic filler, pyromellitic dianhydride (PMDA) as a degradation accelerator, and a mixture of distearyl acid phosphate and monostearyl acid phosphate (“ADK STAB AX-71” available from ADEKA CORPORATION) as a thermal stabilizerwere blended to the polymer composition 2 to obtain a composition. The contents of the cyclic ester, the inorganic filler, and the degradation accelerator contained in the composition are shown in Table 2.

### Examples 6 to 8

Compositions and molded bodies were obtained in the same procedure as in Example 5 except that the blending amounts of the cyclic ester, the inorganic filler, and the degradation accelerator were changed. The contents of the cyclic ester, the inorganic filler and the degradation accelerator in Examples 6 to 8 are shown in Table 2.

### Example 9

A composition and a molded body were obtained in the same procedure as in Example 5 except that the blending amount of the cyclic ester was changed and no degradation accelerator was blended. The contents of the cyclic ester and the inorganic filler in Example 9 are shown in Table 2.

### Examples 10 and 11

Compositions and molded bodies were obtained in the same procedure as in Example 9 except that the blending amounts of the cyclic ester and the inorganic filler were changed. The contents of the cyclic ester and the inorganic filler in Examples 10 and 11 are shown in Table 2.

### Example 12

A composition and a molded body were obtained in the same procedure as in Example 9 except that the blending amount of the cyclic ester was changed and silicon nitride (SiN) was used as an inorganic filler in place of aluminum nitride. The contents of the cyclic ester and the inorganic filler in Example 12 are shown in Table 2.

### Example 13

A composition and a molded body were obtained in the same procedure as in Example 12 except that the blending amount of the inorganic filler was changed. The contents of the cyclic ester and the inorganic filler in Example 13 are shown in Table 2.

### Comparative Examples 1 and 2

Compositions and molded bodies were obtained in the same procedure as in Example 1 except that the blending amounts of the cyclic ester and the degradation accelerator were changed and no inorganic filler was added. The contents of the cyclic ester and the degradation accelerator in Comparative Examples 1 and 2 are shown in Table 3.

### Comparative Examples 3 and 4

Compositions and molded bodies were obtained in the same procedure as in Comparative Example 1 except that the blending amount of the cyclic ester was changed and no degradation accelerator was added. The contents of the cyclic ester and the degradation accelerator in Comparative Examples 3 and 4 are shown in Table 3.

### Comparative Examples 5 and 6

Compositions and molded bodies were obtained in the same procedure as in Comparative Example 3 except that the polymer composition 1 was changed to the polymer composition 2 and the blending amount of the cyclic ester was changed. The contents of the cyclic ester and the degradation accelerator in Comparative Examples 5 and 6 are shown in Table 3.

### Comparative Example 7

A composition and a molded body were obtained in the same procedure as in Comparative Examples 5 and 6, except that the degradation accelerator was blended and no cyclic ester was blended. The content of the degradation accelerator in Comparative Example 7 is shown in Table 3.

### Comparative Example 8

A composition and a molded body were obtained in the same procedure as in Comparative Example 7 except that aluminum nitride was used as an inorganic filler. The content of the degradation accelerator in Comparative Example 8 is shown in Table 3.

### Comparative Example 9

A composition and a molded body were obtained in the same procedure as in Comparative Examples 5 and 6 except that the blending amount of the cyclic ester was changed and aluminum oxide (Al₂O₃) was used as an inorganic filler. The types and contents of the cyclic ester and the inorganic filler in Comparative Example 9 are shown in Table 3.

### Comparative Example 10

A composition and a molded body were obtained in the same procedure as in Comparative Example 9 except that calcium oxide (CaO) was used as an inorganic filler in place of aluminum oxide. The types and contents of the cyclic ester and the inorganic filler in Comparative Example 10 are shown in Table 3.

### Comparative Example 11

A composition and a molded body were obtained in the same procedure as in Example 1 except that the blending amounts of the cyclic ester and the inorganic filler were changed. The contents of the cyclic ester and the inorganic filler in Example 11 are shown in Table 3.

### Comparative Example 12

A composition and a molded body were obtained in the same procedure as in Comparative Example 11 except that the blending amounts of the cyclic ester and the inorganic filler were changed and silicon nitride (SiN) was used as an inorganic filler in place of aluminum nitride. The contents of the cyclic ester, the inorganic filler and the degradation accelerator in Comparative Example 12 are shown in Table 3.

### Comparative Example 13

A composition and a molded body were obtained in the same procedure as in Comparative Example 11 except that the blending amount of the cyclic ester was changed and boron nitride (BN) was used as an inorganic filler in place of aluminum nitride. The contents of the cyclic ester, the inorganic filler and the degradation accelerator in Comparative Example 13 are shown in Table 3.

### Comparative Example 14

A composition and a molded body were obtained in the same procedure as in Example 5 except that calcium carbonate (CaCo₃) was used as an inorganic filler in place of aluminum nitride, and the blending amounts of the cyclic ester, the inorganic filler, and the degradation accelerator were changed. The contents of the cyclic ester, the inorganic filler and the degradation accelerator in Comparative Example 14 are shown in Table 3.

### Comparative Example 15

A composition and a molded body were obtained in the same procedures as in Comparative Example 14 except that the blending amounts of the cyclic ester and the inorganic filler were changed. The contents of the cyclic ester, the inorganic filler and the degradation accelerator in Comparative Example 15 are shown in Table 3.

### Comparative Example 16

A composition and a molded body were obtained in the same procedure as in Example 5 except that the blending amounts of the cyclic ester and the inorganic filler were changed and carbon fiber (CF) was used as an inorganic filler in place of aluminum nitride. The contents of the cyclic ester, the inorganic filler and the degradation accelerator in Comparative Example 16 are shown in Table 3.

### Comparative Examples 17 and 18

Compositions and molded bodies were obtained in the same procedure as in Example 5 except that the blending amount of the cyclic ester was changed and no inorganic filler was added. The contents of the cyclic ester and the degradation accelerator in Comparative Examples 17 and 18 are shown in Table 3.

### Comparative Example 19

A composition and a molded body were obtained in the same procedure as in Example 5 except that the blending amount of the cyclic ester was changed and no inorganic filler and no degradation accelerator were added. The contents of the cyclic ester and the degradation accelerator in Comparative Example 19 are shown in Table 3.

All of the inorganic fillers used in Examples and Comparative Examples were particulate inorganic fillers.

TABLE 2

| | | | | | | | | | | Thickness | |
|---|---|---|---|---|---|---|---|---|---|---|---|
| | | | | | | | | | | reduction rate | Maximum |
| | | | | | | | | | Molded | V₂ (mm/h) in | point stress |
| | | | | | | Degradation | | | body | late stage of | (MPa) in |
| | PGA | | | Inorganic | | accelerator | | Mw | thickness | degradation, | tensile test, |
| | polymer | Cyclic ester (%) | | filler (%) | | (%) | | (g/mol) | (mm) | 49° C. | 49° C. |
| Example 1 | PGA-PEG | Glycolide | 13.9 | AlN | 1 | PMDA | 7 | 222000 | 40 | 0.14 | 67 |
| Example 2 | PGA-PEG | Glycolide | 15.5 | AlN | 3 | PMDA | 7 | 203000 | 40 | 0.14 | 55 |
| Example 3 | PGA-PEG | Glycolide | 16.5 | AlN | 2 | PMDA | 7 | 231000 | 40 | 0.10 | 57 |
| Example 4 | PGA-PEG | Glycolide | 14.9 | AlN | 7 | — | 0 | 230000 | 40 | 0.10 | 52 |
| Example 5 | PGA | Glycolide | 13.7 | AlN | 3 | PMDA | 7 | 220000 | 40 | 0.11 | 65 |
| Example 6 | PGA | Glycolide | 14.4 | AlN | 10 | PMDA | 3 | 220000 | 40 | 0.085 | 55 |
| Example 7 | PGA | Glycolide | 16.8 | AlN | 1 | PMDA | 3 | 230000 | 40 | 0.076 | 65 |
| Example 8 | PGA | Glycolide | 10.5 | AlN | 8 | PMDA | 7 | 230000 | 40 | 0.076 | 58 |
| Example 9 | PGA | Glycolide | 20.0 | AlN | 3 | — | 0 | 229000 | 40 | 0.095 | 59 |
| Example 10 | PGA | Glycolide | 17.8 | AlN | 9 | — | 0 | 220000 | 40 | 0.089 | 56 |
| Example 11 | PGA | Glycolide | 21.4 | AlN | 7 | — | 0 | 210000 | 40 | 0.099 | 52 |
| Example 12 | PGA | Glycolide | 15.2 | SiN | 3 | — | 0 | 190000 | 40 | 0.072 | 72 |
| Example 13 | PGA | Glycolide | 15.2 | SiN | 15 | — | 0 | 190000 | 40 | 0.077 | 58 |

TABLE 3

| | | | | | | | | | | Thickness | Maximum |
|---|---|---|---|---|---|---|---|---|---|---|---|
| | | | | | | | | | Molded | reduction rate V₂ | point stress |
| | | | | | | Degradation | | | body | (mm/h) in late | (MPa) in |
| | PGA | Cyclic ester | | Inorganic filler | | accelerator | | Mw | thickness | stage of | tensile test, |
| | polymer | (%) | | (%) | | (%) | | (g/mol) | (mm) | degradation, 49° C. | 49° C. |
| Comparative Example 1 | PGA-PEG | Glycolide | 18.0 | — | 0 | PMDA | 4.4 | 163000 | 40 | 0.11 | 47 |
| Comparative Example 2 | PGA-PEG | Glycolide | 21.2 | — | 0 | PMDA | 7 | 158000 | 40 | 0.12 | 41 |
| Comparative Example 3 | PGA-PEG | Glycolide | 21.6 | — | 0 | — | 0 | 162000 | 40 | 0.10 | 51 |
| Comparative Example 4 | PGA-PEG | Glycolide | 30 | — | 0 | — | 0 | 182000 | 13 | 0.14 | 30 |
| Comparative Example 5 | PGA | Glycolide | 30 | — | 0 | — | 0 | 220000 | 40 | 0.11 | 39 |
| Comparative Example 6 | PGA | Glycolide | 13.8 | — | 0 | — | 0 | 213000 | 40 | 0.053 | 83 |
| Comparative Example 7 | PGA | — | 0 | — | 0 | PMDA | 7.7 | 210000 | 40 | 0.030 | 83 |
| Comparative Example 8 | PGA | — | 0 | AlN | 5 | PMDA | 7.7 | 150000 | 13 | 0.010 | 77 |
| Comparative Example 9 | PGA | Glycolide | 20 | Al₂O₃ | 10 | — | 0 | Injection molding impossible due to thermal | | | |
| | | | | | | | | decomposition | | | |
| Comparative Example 10 | PGA | Glycolide | 20 | CaO | 10 | — | 0 | Injection molding impossible due to thermal | | | |
| | | | | | | | | decomposition | | | |
| Comparative Example 11 | PGA-PEG | Glycolide | 26.7 | AlN | 7 | PMDA | 7 | 187000 | 40 | 0.170 | 25 |
| Comparative Example 12 | PGA-PEG | Glycolide | 35.8 | SiN | 5 | PMDA | 7 | 184000 | 40 | 0.290 | 19 |
| Comparative Example 13 | PGA-PEG | Glycolide | 33.0 | BN | 7 | PMDA | 7 | 211000 | 40 | 0.160 | 35 |
| Comparative Example 14 | PGA | Glycolide | 15.2 | CaCO₃ | 10 | PMDA | 5 | 220000 | 40 | 0.074 | 51 |
| Comparative Example 15 | PGA | Glycolide | 14.0 | CaCO₃ | 25 | PMDA | 5 | 220000 | 40 | 0.100 | 33 |
| Comparative Example 16 | PGA | Glycolide | 12.7 | CF (powder) | 5 | PMDA | 7 | 220000 | 40 | 0.081 | 51 |
| Comparative Example 17 | PGA | Glycolide | 12 | — | — | PMDA | 7 | 200000 | 40 | 0.062 | 68 |
| Comparative Example 18 | PGA | Glycolide | 18 | — | — | PMDA | 7 | 240000 | 40 | 0.062 | 64 |
| Comparative Example 19 | PGA | Glycolide | 20 | — | — | — | — | 220000 | 40 | 0.069 | 63 |

It was found that, in Comparative Examples 1 to 7 and 17 to 19 in which no inorganic filler was added, only one of the maximum point stress of 52 MPa or greater and the thickness reduction rate in the late stage of degradation of 0.07 mm/hour or greater was satisfied, whereas in Examples 1 to 14 in which the inorganic filler was added, both of the two characteristics were satisfied. On the other hand, as in Comparative Example 8, even when the inorganic filler was added in the absence of cyclic ester, the degradation accelerating effect was not found, and therefore, it was found that the cyclic ester and the inorganic filler concertedly act to enhance the degradation accelerating effect. In addition, as shown in Comparative Examples 9 and 10 and Comparative Examples 14 to 16, it was found that when an inorganic filler that is not a nitride was added, injection molding was impossible to be conducted due to thermal decomposition, or only one of the maximum point stress of 52 MPa or greater and the thickness reduction rate in the late stage of degradation of 0.07 mm/hour or greater could be satisfied. Furthermore, as shown in Comparative Examples 11 to 13, it was found that when the content of the cyclic ester was out of the range of 10 mass % or more and 22 mass % or less, the maximum point stress of 52 MPa or greater was could not be satisfied.

### INDUSTRIAL APPLICABILITY

The molded body according to an embodiment of the present invention has a high degradation rate and can be used for, for example, a downhole tool for well drilling.

1. A molded body comprising a composition containing a glycolic acid polymer, a cyclic ester, and an inorganic filler,
wherein, in the composition, a content of the cyclic ester is 10 mass % or more and 22 mass % or less, and a content of the inorganic filler is 0.1 mass % or more and 15 mass % or less, the inorganic filler is at least one inorganic filler selected from the group consisting of aluminum nitride and silicon nitride, and
the molded body has a thickness or diameter of greater than 5 mm.

2. The molded body according to claim 1, wherein a thickness reduction rate of the molded body after thickness reduction of 5 mm or greater from its initial thickness when held in water at 49° C. is 0.070 mm/hour or greater.

3. The molded body according to claim 1, wherein the molded body has a tensile strength at 49° C. of 52 MPa or greater, and
a thickness reduction rate of the molded body after thickness reduction of 5 mm or greater from its initial thickness when held in water at 49° C. is 0.070 mm/hour or greater.

4. The molded body according to claim 1, wherein the cyclic ester in the composition is glycolide.

5. The molded body according to claim 1, wherein the content of the cyclic ester in the composition is 20 mass % or less.

6. The molded body according to claim 5, wherein the content of the inorganic filler in the composition is 10 mass % or less.

7. The molded body according to claim 1, wherein the glycolic acid polymer is a copolymer in which a linear polymer chain A including a repeating unit derived from glycolic acid is chemically bonded to a polymer chain B different from the polymer chain A.

8. The molded body according to claim 7, wherein the polymer chain B is derived from a polymer compound having a glass transition temperature of lower than 45° C.

9. The molded body according to claim 7, wherein the glycolic acid polymer is a block copolymer of the polymer chain A and the polymer chain B.

10. The molded body according to claim 1, wherein the glycolic acid polymer is a homopolymer of glycolic acid.

11. The molded body according to claim 1, wherein the composition has a weight average molecular weight of 150000 or greater and 500000 or less.

12. A downhole tool member comprising the molded body described in claim 1.

13. A downhole tool comprising the downhole tool member described in claim 12.
